(19) United States
(12) Patent Application Publication
(10) Pub. No.: US 2026/0329494 A1
(43) Pub. Date: Oct. 22, 2026

(54) STORAGE MEDIUM STORING PROGRAM, INFORMATION PROCESSING APPARATUS, AND LABEL DATA SHARING SYSTEM

(71) Applicant: BROTHER KOGYO KABUSHIKI KAISHA, Nagoya (JP)

(72) Inventors: Fuyuko ITO, Yokkaichi (JP); Ryoji BAN, Kiyosu (JP); Aiko YASUI, Nagoya (JP); Jun YAMADA, Nagoya (JP)

(21) Appl. No.: 19/468,181

(22) Filed: Feb. 3, 2026

Related U.S. Application Data
(63) Continuation of application No. PCT/JP2024/028033, filed on Aug. 6, 2024.

(30) Foreign Application Priority Data
Sep. 29, 2023 (JP) 2023-169338

(51) Int. Cl. G06F 3/12

(52) U.S. Cl. CPC G06F 3/1238; G06F 3/1222; G06F 3/1239

(57) ABSTRACT

An information processing apparatus requests a login to a server by using a user ID of a login user, the server configured to access a purchase information database storing purchase information indicating, for each user ID, whether paid content or function has been purchased; in a logged-in state, downloads, from the server, at least one label data stored in the server and stores the downloaded label data in a memory; acquires, via the server, the purchase information corresponding to the user ID; accepts selection of label data to be used, via a user interface; determines, based on the acquired purchase information, whether the selected label data includes a setting of unpurchased paid content or function; and in response to determining that the selected label data includes the setting, controls the user interface to notify that the selected label data includes unpurchased paid content or function.

### REFERENCE TO RELATED APPLICATIONS

This is a Continuation Application of International Application No. PCT/JP2024/028033 filed on Aug. 6, 2024, which claims priority from Japanese Patent Application No. 2023-169338 filed on Sep. 29, 2023. The entire content of each of the prior applications is incorporated herein by reference.

### BACKGROUND ART

In a system, a server for storing various content data is prepared on the Internet, and a user downloads content data through the Internet.

### SUMMARY

For example, in a point management system, when photo data is uploaded from a PC of a user A to a WWW server, and the photo data is purchased and downloaded from the WWW server by a PC of a user B, points according to the purchase amount are added to the user B as the purchaser, and points according to the data size of the photo data are also added to the user A as the posting user when the photo data is uploaded or downloaded.

In recent years, a system for utilizing label data used for printing a label by a label printer has been studied. Label data is composed by combining various contents and functions, and some of the contents and functions are paid. The label data includes a setting related to paid content or function.

In order for a user who has downloaded label data including a setting of paid content or function to use the label data, the user purchases the label data. However, it is difficult for a user who has downloaded the content or function, that is, a user who uses the label data, to grasp whether the paid content or function has been purchased.

According to one aspect, this specification discloses a non-transitory computer-readable storage medium storing a program including a set of program instructions for an information processing apparatus including a computer. The set of program instructions, when executed by the computer, causes the information processing apparatus to perform requesting a login to a server by using a user ID of a login user. The server is configured to store label data. The label data is printable by a label printer. The label data is configured to include a setting of paid content or function. The server is configured to access a purchase information database. The purchase information database stores purchase information indicating, for each of a plurality of user IDs, whether paid content or function has been purchased. Thus, the login to the server is requested by using the user ID. The set of program instructions, when executed by the computer, causes the information processing apparatus to perform, in a logged-in state on the server, downloading, from the server, at least one label data stored in the server and storing the downloaded label data in a memory of the information processing apparatus. Thus, the label data is downloaded from the server and is stored in the memory. The set of program instructions, when executed by the computer, causes the information processing apparatus to perform acquiring, via the server, the purchase information corresponding to the user ID of the login user. Thus, the purchase information corresponding to the user ID is acquired via the server. The set of program instructions, when executed by the computer, causes the information processing apparatus to perform selecting label data to be used. Thus, selection of label data to be used is accepted via the user interface. The set of program instructions, when executed by the computer, causes the information processing apparatus to perform determining, based on the acquired purchase information, whether the selected label data includes a setting of unpurchased paid content or function. Thus, whether the selected label data includes the setting of unpurchased paid content or function is determined based on the acquired purchase information. The set of program instructions, when executed by the computer, causes the information processing apparatus to perform, in response to determining that the selected label data includes the setting of unpurchased paid content or function, controlling a user interface of the information processing apparatus to notify that the selected label data includes unpurchased paid content or function. Thus, the user interface notifies that the selected label data includes unpurchased paid content or function.

When the paid content or function included in the selected label data is not purchased, the information processing apparatus having the program of the above configuration executes the program to notify that the selected label data includes unpurchased paid content or function. This enables the login user who uses the program to notice that unpurchased content or function is included. As a result, purchase of unpurchased content or function is promoted.

An information processing apparatus, a label data sharing system, a control method, and a computer-readable storage medium storing the program for realizing the functions of the program are also novel and useful.

According to the technology disclosed in the present specification, a technology is realized in which label data including paid content or function is easily used in a system that utilizes label data.

### BRIEF DESCRIPTION OF DRAWINGS

FIG. 1 schematically illustrates a label data sharing system.

FIG. 2A illustrates an example of data structure of a user database.

FIG. 2B illustrates an example of data structure of a label database.

FIG. 3 is a sequence diagram illustrating an example of a content purchase process.

FIGS. 4A, 4B, 4C, 4D and 4E illustrate an example of screen transition.

FIGS. 5A and 5B are sequence diagrams illustrating an example of a purchase information acquisition process.

FIG. 6 is a sequence diagram illustrating another example of a purchase information acquisition process.

FIG. 7A is a sequence diagram illustrating an example of a label posting process.

FIG. 7B illustrates an example of label data.

FIG. 8 is a sequence diagram illustrating a download process.

FIGS. 9A, 9B, 9C and 9D illustrate an example of screen transition.

FIG. 10 is a sequence diagram illustrating a label data use process.

### DESCRIPTION

An information processing apparatus used in a label data sharing system of an embodiment will be described in detail below with reference to the accompanying drawings. The present specification discloses an information processing apparatus which downloads posted label data and uses the label data.

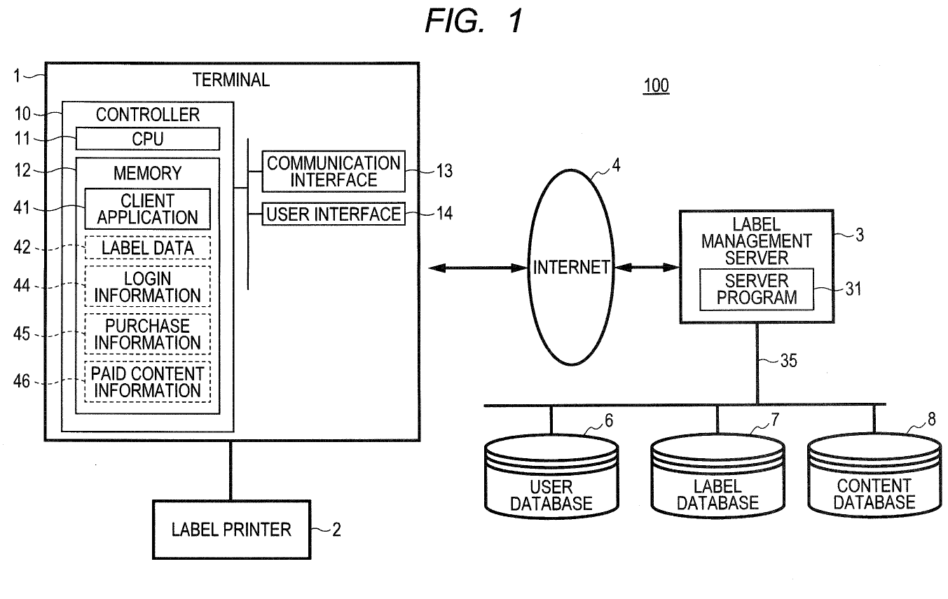

As shown in FIG. 1, a label data sharing system 100 (hereinafter abbreviated as “system 100”) of this embodiment is a system provided to a user by, for example, a vendor of a label printer. The system 100 includes a terminal 1 and a label management server 3, which are connected to each other via an Internet 4. The terminal 1 is owned by the owner or user of the label printer (hereinafter referred to as “user”). The terminal 1 is connectable to a label printer 2. The label management server 3 is an example of a “server”. The Internet 4 is an example of a “network”. Although one terminal 1 is shown in FIG. 1, in practice, a large number of terminals 1 are connected to the label management server 3.

The label printer 2 is a printing apparatus which includes, for example, a thermal transfer type print head and performs printing while unrolling a tape wound in a roll shape. The label printer 2 prints an image on a tape contained inside and conveys the tape based on a print job received from the terminal 1, for example, and projects a printed portion to the outside of the apparatus. From the tape projecting from the apparatus, a label having a particular label length and label width is created. The label length is the length in the direction in which the label is discharged from the label printer 2. The label width is the length in the direction perpendicular to the label length. The label printer 2 is usable by replacing a plurality of types of tapes depending on the model.

The label printer 2 is connected to the terminal 1 by wireless LAN communication such as Wi-Fi or short-range wireless communication such as Bluetooth. Alternatively, the label printer 2 and the terminal 1 may be connected by a wire using the USB communication standard. The “Wi-Fi is a registered trademark of Wi-Fi Alliance. The “Bluetooth” is a registered trademark of Bluetooth SIG, Inc.

The label management server 3 is a device having at least a storage function and a communication function. The label management server 3 executes various functions by executing a server program 31. The label management server 3 has a web server function of providing a web page in response to a request from the terminal 1. The label management server 3 has a function of accepting posting of label data and transmitting label data to be posted to the terminal 1. The label management server 3 has a function of managing purchase of paid contents or functions (that is, contents and functions that are usable upon payment) for each of a plurality of user IDs. Each function will be described later.

The label management server 3 is connected to, for example, a user database 6, a label database 7, and a content database 8 such that the databases 6, 7, and 8 are accessible from the label management server 3. The user database 6 is an example of a “purchase information database”. The label management server 3 may be connected to the databases 6, 7, and 8 by a wire 35 or by wireless. The databases 6, 7, and 8 may be provided in the label management server 3 or in a server different from the label management server 3. The user database 6 and the label database 7 may be configured as a single integrated database. The user database 6, the label database 7, and the content database 8 may be provided inside or outside the label management server 3.

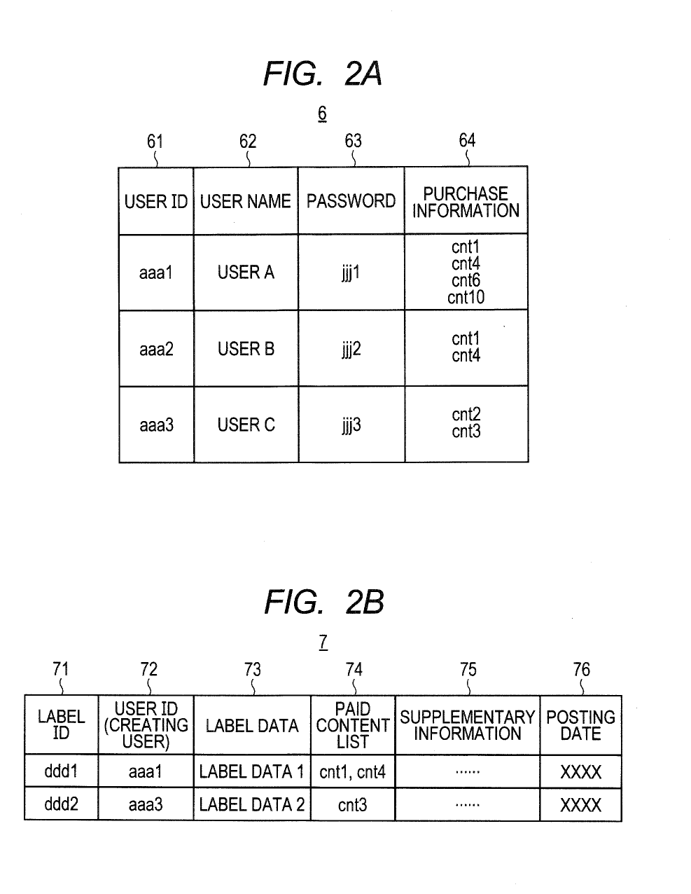

As shown in FIG. 2A, the user database 6 stores a record including a user ID 61, a user name 62, a password 63, and purchase information 64 for each user who uses the terminal 1.

The user ID 61 is identification information for identifying a user who can use the system 100, and specifies a user who uses the terminal 1. The user name 62 is, for example, a name or nickname of an individual or a group (corporation) of the user who uses the label data sharing system 100 of this embodiment. The password 63 is a password set by each user stored in the user name 62.

The purchase information 64 is information indicating paid contents and functions (features) purchased by each user stored in the user name 62. The paid contents include, for example, special fonts, pictographs (emojis), character images, decoration images, and special frames. The paid functions include, for example, a character color inversion function, a horizontal flipping function, a repeated printing function, and a database printing function. A content ID is assigned to each of the contents or functions to identify the contents or functions. The purchase information 64 stores a paid content ID of a paid content or function purchased by the user corresponding to the user ID. In addition, personal information such as an email address, an address, and a telephone number may be registered in the user database 6 for each user.

The label database 7 stores a plurality of label data printable by a label printer. The label data may be label data uploaded (that is, posted) from the terminal 1 to the label management server 3 by a user who uses the label data sharing system 100 of this embodiment (hereinafter referred to as “posted label data”), or label data registered (stored) in the label management server 3 by a vendor (manufacturer) of the label printer 2. As shown in FIG. 2B, the label database 7 stores a record including a label ID 71, a user ID (creating user) 72, label data 73, a paid content list 74, supplementary information 75, and a posting date 76 for each label data. The user ID (creating user) 72 may be a user name (creating user).

The label ID 71 is a serial number sequentially assigned to each label data registered in the label management server 3 in the system 100 of this embodiment. The user ID (creating user) 72 is the user ID 61 of the user who posted the label data using the system 100. The user ID (creating user) 72 of the label data created by a person other than the user may be an administrator ID, a vendor ID of the vendor that created the label data, or a blank.

The label data 73 is stored in the label management server 3. The label data 73 stores the type, function, and arrangement of an object included in the label indicated by the label data 73. In a case where a specific content is used, the label data 73 further stores information of the content. The content or function used for the label data 73 may be paid or free. The label data may include tape information such as a tape model number or printer information.

The paid content list 74 is a list created by the label management server 3. The paid content list 74 stores paid content IDs of paid contents or functions stored in the label data 73. The supplementary information 75 is stored as information supplemented when the label data 73 is posted to the label management server 3. The posting date 76 is information indicating the date and time when the label data is registered in the label database 7.

The content database 8 stores content or function that is set for each type of object. For example, the content database 8 stores a paid content ID and paid content information indicating the type of paid content or function. The paid content information may include information indicating the structure of the content. The content database 8 may store free contents or functions.

Referring back to FIG. 1, the terminal 1 is an information processing apparatus having a communication function, a storage function, a display function, and an operation function. The terminal 1 of the present embodiment is a smartphone, but may be a tablet or a personal computer.

In the terminal 1, a communication interface 13 and a user interface 14 are electrically connected to a controller 10 including a CPU 11 and a memory 12. The terminal 1 is an example of an “information processing apparatus”. The CPU 11 is an example of a “computer”. The controller 10 may be an example of a “computer”. The controller 10 in FIG. 1 is a generic name for hardware and software used for controlling the terminal 1, and does not necessarily represent single hardware actually present in the terminal 1.

The CPU 11 of the terminal 1 executes various processes according to programs read from the memory 12 and based on operations of the user. The memory 12 stores various programs such as a client application program (hereinafter referred to as “client application”) 41. The memory 12 stores various data such as label data 42, login information 44, purchase information 45, and paid content information 46. The memory 12 is also used as a work area when various processes are executed. A buffer provided in the CPU 11 is also an example of a memory. Note that an example of the memory 12 is not limited to a ROM, a RAM, an HDD, and so on built in the terminal 1, but may be a storage medium that is read and written by the CPU 11, for example, a recording medium such as a CD-ROM, a DVD-ROM, or a USB memory.

The client application 41 has a function of creating or editing label data. The client application 41 has a function of causing the label printer 2 to print label data. The client application 41 has a function of storing the label data 42 downloaded from the label management server 3 in the memory 12. The client application 41 has a function of accepting a log-in operation when logging in to the label management server 3. The client application 41 has a browser function and displays a web page provided from the label management server 3.

The client application 41 has a function of storing the paid content information 46 of the paid content or function that is purchased from the label management server 3 in the memory 12. The client application 41 has a function of acquiring the purchase information 45 corresponding to the login ID from the label management server 3 and storing the purchase information 45 in the memory 12. The client application 41 has a function of determining whether the label data to be used includes any unpurchased paid content or function, based on the purchase information 45 corresponding to the login ID, which is the purchase information 45 acquired from the label management server 3. Each function will be described later. The client application 41 is an example of a “program”.

The communication interface 13 includes hardware for controlling communication with an external device such as the label printer 2 or the label management server 3. The user interface 14 includes hardware for displaying a screen for notifying the user of information and hardware for receiving an operation by the user. The user interface 14 may be a combination of a display configured to display information and an input device having an input reception function, such as a mouse and a keyboard, or may be a touch panel having a display function and an input reception function. The user interface 14 may also include a device configured to input or output sound, such as a microphone and a speaker.

Next, the operation of the terminal 1 in the label data sharing system 100 will be described. Each processing step in the present embodiment basically indicates a process of the CPU 11 mainly in accordance with an instruction described in a program such as the client application 41. The process executed by the CPU 11 includes hardware control using an API of an OS. In this specification, the operation of each program will be described without describing the OS in detail.

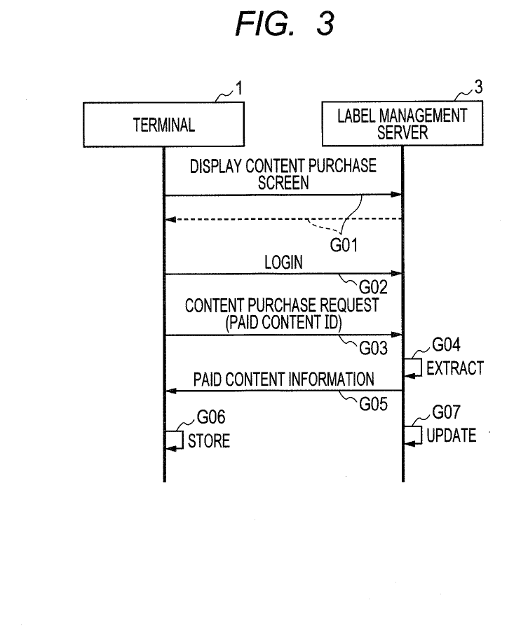

An example of a procedure of a content purchase process will be described with reference to FIG. 3. For example, the label management server 3 provides a content purchase screen for the user to purchase paid content or functions. The content purchase screen is assigned with a URL. The client application 41 accesses the label management server 3 based on the URL of the content purchase screen and displays the content purchase screen on the user interface 14 of the terminal 1 (G01). For example, as described later, the client application 41 receives web page information for a label search screen from the label management server 3 and displays the label search screen on the terminal 1. The label search screen includes a point content tag associated with the URL of the content purchase screen. When the point content tab is operated, the client application 41 receives the web page information for the content purchase screen from the label management server 3 and displays the web page on the terminal 1.

The content purchase screen displays paid contents and functions downloadable to the terminal 1 so as to be selectable. Each paid content or function is associated with a paid content ID. The client application 41 logs in to the label management server 3 (G02), and when the client application 41 accepts an operation of a purchase execution button in the content purchase screen in a state where a paid content or function is selected in the content purchase screen, the client application 41 transmits a content purchase request to the label management server 3 (G03). The request is attached with a paid content ID corresponding to the selected paid content or function. The content purchase screen may display free contents and functions so as to be selectable.

When the payment procedure is completed, the label management server 3 reads out, from the content database 8, the paid content information 46 corresponding to the content ID associated with the paid content or function selected on the content purchase screen (G04). The label management server 3 transmits the read paid content information 46 to the terminal 1 that has output the content purchase request (G05). The terminal 1 receives the paid content information 46 via the communication interface 13 and stores the paid content information 46 in the memory 12 (G06). The label management server 3 that has transmitted the paid content information 46 accesses the user database 6 and updates the purchase information based on the purchased content in the record including the user ID of the login user.

The user may purchase a content or function by inputting the URL of the content purchase screen to a program other than the client application 41, such as a browser, in the terminal 1 to access the label management server 3. The user may also log in to the label management server 3 from a plurality of terminals 1 using his or her user ID and password, and purchase contents or functions. In this case, the label management server 3 also updates the user database 6.

A purchase information acquisition process will be described. When a user uses label data including paid content or function, the user purchases the paid content or function. The paid contents or functions purchased by users are different from user to user.

The label management server 3 manages purchase information for each user in the user database 6. Therefore, the label management server 3 determines whether unpurchased content or function which has not been purchased by the login user is included in the label data based on the purchase information corresponding to the login ID, and when the label management server 3 determines that unpurchased content or function is included, the label management server 3 does not transmit the label data to the terminal 1, thereby restricting the use of the label data including the content or function which has not been purchased by the user.

However, in a case where a plurality of users share a single terminal 1, a user downloads label data and another user is able to access the label data on the terminal 1 even if the other user has not purchased the paid content or function included in the label data. In a case where label data is shared by a plurality of terminals 1 using a file sharing function, a user different from a user who downloads label data is able to access the label data from another terminal 1 using the file sharing function even if the different user has not purchased a paid content or function included in the label data. The use of paid content or function due to these accesses cannot be restricted by the label management server 3. Therefore, in this embodiment, the terminal 1 also determines whether the label data includes unpurchased paid content or function based on the purchase information.

Therefore, the client application 41 acquires the purchase information from the label management server 3 in a state where the client application 41 is logged in to the label management server 3. The login method may be manual or automatic.

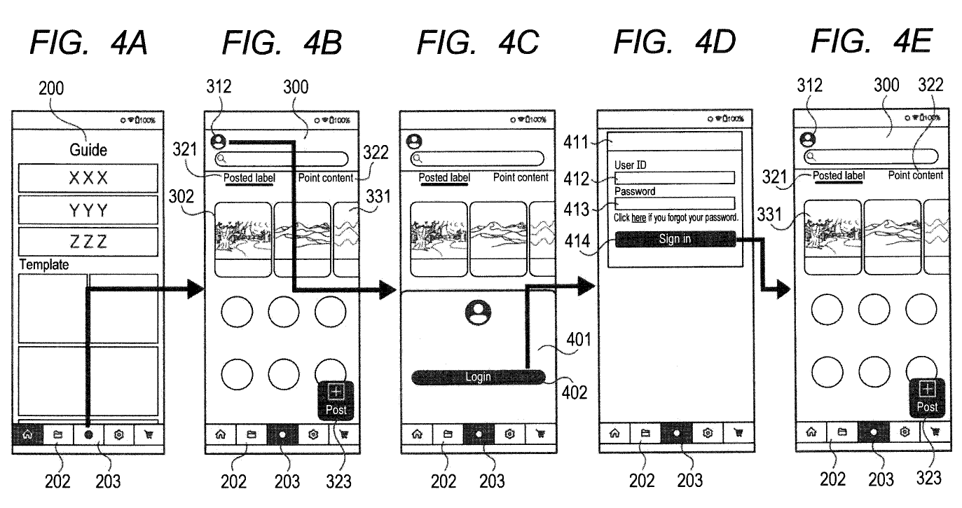

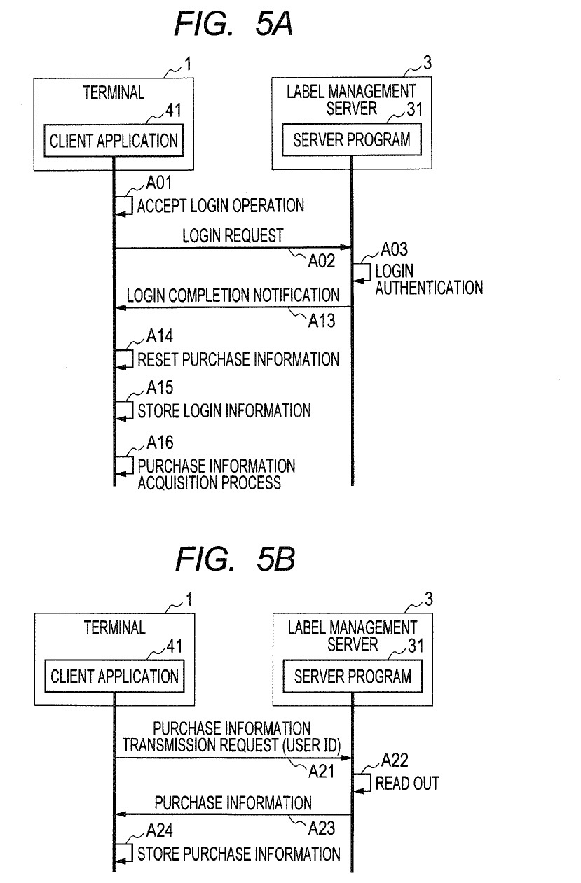

Referring to FIGS. 4A to 4E, 5A and 5B, the procedure for acquiring purchase information will be described. For example, when the client application 41 is started in a state where the login information 44 is not stored in the memory 12, the client application 41 causes the user interface 14 of the terminal 1 to display a home screen 200 shown in FIG. 4A in a state where the user is not logged in to the label management server 3.

For example, when the client application 41 receives an operation of a server use button 203 displayed on the home screen 200, the client application 41 accesses the label management server 3 and causes the user interface 14 to display a label search screen 300 shown in FIG. 4B provided from the label management server 3. The label search screen 300 accepts a selection of a download target from the label data registered (stored) in the label database 7. In response to receiving an operation of a user button 312 displayed on the label search screen 300, the client application 41 causes the terminal 1 to display a login confirmation screen 401 shown in FIG. 4C provided from the label management server 3.

In response to receiving an operation of a login button 402 displayed on the login confirmation screen 401, the client application 41 causes the terminal 1 to display a login screen 411 shown in FIG. 4D provided from the label management server 3. As shown in FIG. 5A, the client application 41 accepts a login operation by accepting an operation of a sign-in button 414 of the login screen 411 in a state where the user ID and the password of the user who uses the terminal 1 are input in a user ID input field 412 and a password input field 413 displayed on the login screen 411. In this case (A01), the client application 41 transmits a login request to the label management server 3 (A02). Steps A01 to A02 are examples of “login process”.

In response to receiving the login request, the label management server 3 performs login authentication based on the user ID and password input on the login screen 411 (A03), and when the login is successful, transmits a login completion notification to the terminal 1 (A13). Further, as shown in FIG. 4E, the label management server 3 closes the login screen 411 and displays the label search screen 300 on the terminal 1.

As shown in FIG. 5A, in response to receiving the log-in completion notification via the communication interface 13, the client application 41 resets the purchase information 45 stored in the memory 12 (A14). This avoids the client application 41 from determining whether the label data includes unpurchased paid content or function based on the purchase information corresponding to the user ID of the last login user. Thus, determination accuracy is improved.

The client application 41 stores the user ID and the password used for the login as the login information 44 in the memory 12 (A15). This enables the client application 41 to detect that the client application 41 is logged in to the label management server 3. The client application 41 may determine whether the user has logged in by using a method other than the presence or absence of the login information 44, such as a flag.

Further, the client application 41 executes a purchase information acquisition process (A16). A16 is an example of “acquisition process”. More specifically, as shown in FIG. 5B, the client application 41 requests the label management server 3 to transmit the purchase information (A21). The request is appended with the user ID included in the login information 44 stored in the memory 12, that is, the user ID of the login user.

The label management server 3 accesses the user database 6 and reads out the purchase information 45 corresponding to the received user ID (A22). That is, the label management server 3 reads out the purchase information 45 corresponding to the user ID of the login user. The purchase information 45 includes the paid content ID of the paid content or function that the login user has purchased. The label management server 3 transmits the read purchase information 45 to the client application 41 (A23). The client application 41 stores the received purchase information 45 in the memory 12 (A24). In this way, the client application 41 acquires the purchase information 45 corresponding to the user ID of the login user.

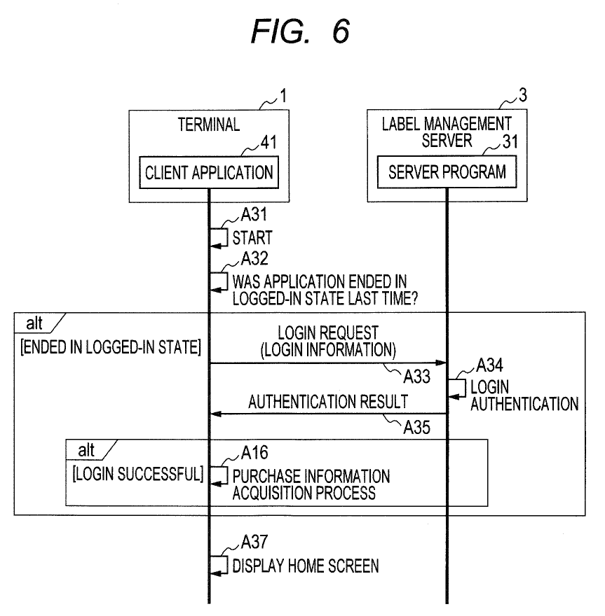

Next, referring to FIG. 6, a procedure for acquiring purchase information in the case of automatic login at startup will be described. For example, when the client application 41 is started (A31), the client application 41 determines whether the client application 41 has been ended in the logged-in state last time (A32). When the login information 44 is stored in the memory 12, the client application 41 determines that the client application 41 has ended in the logged-in state last time. In this case (alt: ended in logged-in state), the client application 41 transmits a login request to the label management server 3 (A33). The login request is appended with the login information 44 stored in the memory 12.

The label management server 3 verifies the received login information 44 against the user database 6 to perform login authentication (A34). The label management server 3 transmits the authentication result to the client application 41 (A35). When the login is successful (alt: login successful), the client application 41 executes a purchase information acquisition process based on the user ID included in the login information 44 stored in the memory 12, that is, the user ID of the last login user (A16). The purchase information acquisition process has been described above, and therefore, the description will be omitted. The client application 41 acquires the purchase information corresponding to the user ID of the last login user. Thereafter, the client application 41 causes the user interface 14 to display the home screen 200 in a state where the client application 41 has logged in to the label management server 3 (A37).

When the client application 41 is started in a state where the login information 44 is not stored in the memory 12 (A31), the client application 41 determines that the client application 41 did not end in the logged-in state last time. In this case, the client application 41 does not acquire the purchase information from the label management server 3 and displays the home screen 200 on the user interface 14 in a state where the user is not logged in to the label management server 3 (A37).

The user may access the label management server 3 from a program or a device other than the client application 41 and purchase paid contents and functions. Therefore, the client application 41 of this embodiment executes the purchase information acquisition process shown in FIG. 5B also in a case where the server use button 203 shown in FIG. 4E is operated by the user interface 14, for example. In this case, the client application 41 acquires the purchase information from the label management server 3 by using the user ID included in the login information 44 stored in the memory 12, that is, the user ID of the login user at the time of operating the server use button 203.

Further, the client application 41 of this embodiment executes the purchase information acquisition process shown in FIG. 5B also when label data stored in the label management server 3 is selected and the label data is opened in a state where the client application 41 is logged in to the label management server 3. This will be discussed later.

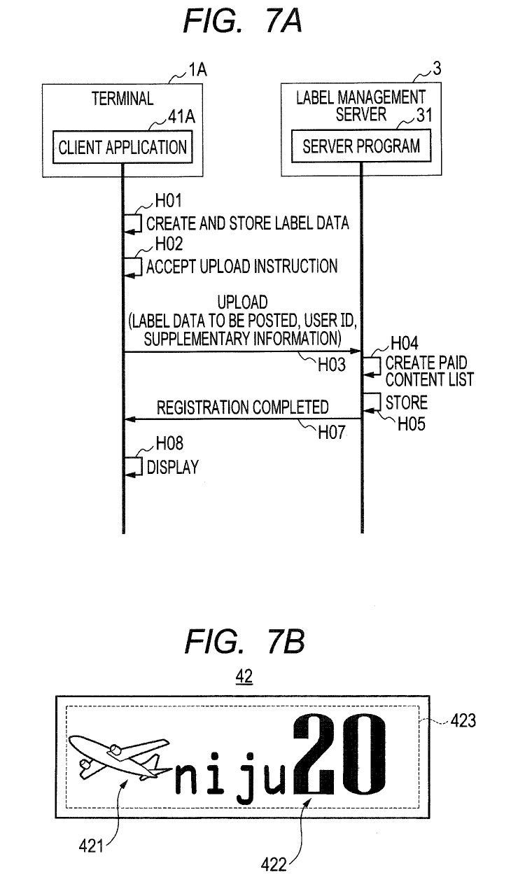

Next, the procedure of a label posting process will be described with reference to FIGS. 7A and 7B. Here, a case where a user A (hereinafter referred to as “posting user A”) posts label data using a terminal 1A will be described as an example. For convenience, the terminal 1 and its components used by the posting user A are given a suffix “A”. The terminal 1A is an example of a “first information processing apparatus”.

As shown in FIG. 7A, the posting user A starts a client application 41A of the terminal 1A, and creates and stores the label data 42 to be posted on the terminal 1A (H01). For example, as shown in FIG. 7B, the posting user A selects a text object on an editing screen provided by the client application 41 and inputs a character string “niju20” to the label data 42. The posting user A enters a special pictogram (emoji) of an airplane before the character string, and selects the character string “20” to set a special font. Thus, the label data 42 including paid content 421 of the special pictogram and paid content 422 of the special font is created.

When creation of the label data 42 is completed, the posting user A operates a save button on the editing screen, and saves the created label data 42 in a memory 12A. More specifically, the client application 41A stores information constituting the label of the label data 42 when the label data 42 is stored. The information constituting the label includes, for example, the type of object “text object”, the arrangement of the text object, the special pictogram input to the text object, the character string “niju20”, and the special font set for the character string “20”. The client application 41A stores, in the label data, the paid content ID of the paid content included in the label data 42. Thus, the paid content ID of the paid content and the function set in the label data 42 is easily determined from the label data.

For example, when the client application 41A accepts an operation of the server use button 203 displayed on the home screen 200 shown in FIG. 4A after the label data 42 is stored in the memory 12A by the posting user A, the client application 41A causes the user interface 14 to display the label search screen 300 shown in FIG. 4B provided from the label management server 3. The client application 41A logs in to the label management server 3, accepts an operation of a post button 323 displayed on the label search screen 300, and then the client application 41A displays a posting screen (not shown) provided from the label management server 3 on the terminal 1A. The process of the terminal 1A logging in is an example of a “first login process”.

The client application 41A accepts, on the posting screen (not shown), a selection of label data 42 to be posted from among the label data stored in the terminal 1A, and further accepts an input of supplementary information. The supplementary information includes, for example, a label name, a category, a description of the label, and an image showing an example of use of the label. As shown in FIG. 7A, the client application 41A receives an upload instruction by operating a new post button displayed on the posting screen (not shown) (H02), and uploads the label data 42 to be uploaded to the label management server 3 (H03). The user ID of the log-in user, that is, a user ID “aaa1” of the posting user A, and supplementary information input on the posting screen (not shown) are appended to the uploaded label data 42. H03 is an example of “upload process”.

The label management server 3 reads the paid content ID from the received label data 42 and creates a paid content list (H04). For example, the label management server 3 extracts a paid content ID “cnt1” of the special pictogram and a paid content ID “cnt4” of the special font from the posted label data 42, and adds the paid content IDs to the paid content list.

The label management server 3 stores the received label data 42 and the created paid content list in the label database 7 (H05). More specifically, the label management server 3 creates a new label ID “ddd1” and stores the label ID as a new label ID 71 in the label database 7 in FIG. 2B. The label management server 3 stores the received user ID “aaa1” of the posting user A, the posted label data 42, and the supplementary information as the user ID (creating user) 72, the label data 73, and the supplementary information 75, respectively, as records corresponding to the new label ID 71. The label management server 3 stores the paid content list created in H04 as the paid content list 74. The label management server 3 stores the date of posting as the posting date 76. Thus, the posted label data 42 uploaded from the terminal 1A to the label management server 3 by the posting user A is registered in the label database 7, and the label management server 3 is ready to provide the posted label data 42 in response to a request from a user other than the posting user A.

When the registration of the posted label data 42 is completed, the label management server 3 notifies the client application 41 of the completion of the registration (H07). The client application 41A causes a user interface 14A of the terminal 1A to display a message indicating that the registration is completed (H08). This enables the posting user A to know that the registration of the posted label data 42 is completed.

Next, a procedure of a download process for downloading label data will be described. In this example, a user B different from the posting user A downloads the posted label data 42 to a terminal 1B different from the terminal 1A, and uses the posted label data 42. For convenience, the terminal 1 and its components used by the user B are denoted by a suffix “B”. The user B is an example of a “first login user”. The terminal 1B is an example of a “second information processing apparatus”. The download target is not limited to the posted label data, but may be label data provided by a vendor of a label printer, for example.

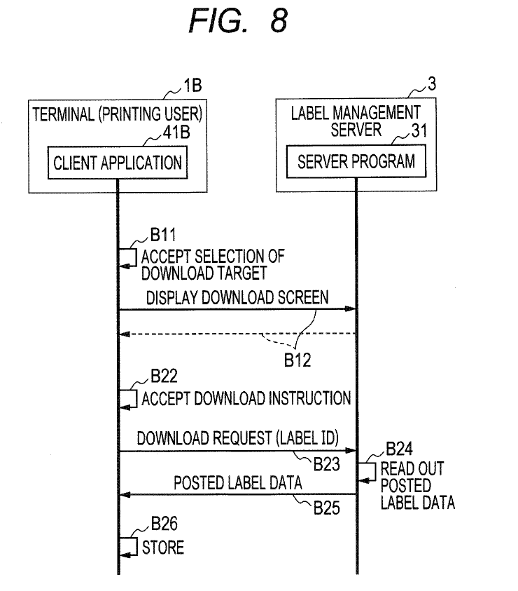

For example, the user B starts a client application 41B and logs in to the label management server 3 using a user ID “aaa2” of the user B. The process of the user B logging in to the label management server 3 is an example of “second login process”. As shown in FIG. 4E, the label management server 3 displays the label search screen 300 on the terminal 1B in a state where the user B is logged in to the label management server 3. The label search screen 300 displays images or thumbnail images of label data stored in the label database 7 in a selectable manner. The client application 41B accepts an operation of selecting an image or thumbnail image 331 corresponding to the posted label data 42 on the label search screen 300, thereby accepting selection of the label data of the download target as shown in FIG. 8 (B11).

In response to receiving the selection of the download target, the client application 41B causes a user interface 14B to display a download screen provided from the label management server 3 (B12). The download screen includes a download execution button. In response to receiving an operation of the download execution button, the client application 41B accepts a download instruction (B22) and requests the label management server 3 to transmit the selected label data (B23). The download request includes the label ID “ddd1” of the selected posted label data 42 and the user ID “aaa2” of the user B who has instructed the download of the posted label data 42. The number of label data selected as the download target is not limited to one, and may be plural.

In response to receiving the download instruction, the label management server 3 accesses the label database 7 and reads out the posted label data 42 from the label data 73 associated with the received label ID “ddd1” (B24). The label management server 3 transmits the read posted label data 42 to the client application 41B (B25).

In response to receiving the posted label data 42 via a communication interface 13B, the client application 41B stores the data in the memory 12B (B26). As shown in FIG. 2B, the posted label data 42 includes paid content IDs “cnt1” and “cnt4”. As shown in FIG. 2A, the paid contents IDs “cnt1” and “cnt4” are included in the purchase information of the user B. That is, the user B has already purchased the paid content 421 of the special pictogram and the paid content 422 of the special font that are set in the selected posted label data 42. Therefore, the user B is allowed to use the posted label data 42 downloaded to the terminal 1B.

Next, a process for using label data will be described. In this example, a user C uses the terminal 1B, which is shared with the user B, and uses the posted label data 42 which has been downloaded to the terminal 1B by the user B. For convenience, the terminal 1 and its components used by the user C are denoted by a suffix “B”. The user C is an example of a “second login user”.

For example, the user C starts the client application 41B and logs in to the label management server 3 using a user ID “aaa3” of the user C. In this case, the client application 41B acquires purchase information corresponding to the user ID “aaa3” of the user C who uses the posted label data 42 from the label management server 3.

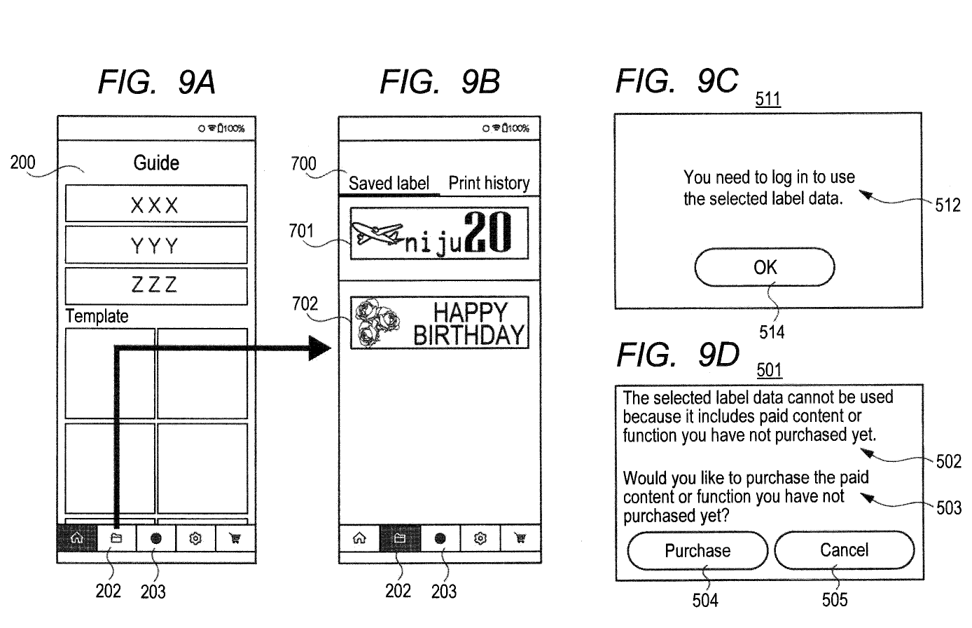

For example, in response to receiving an operation of a file button 202 displayed on the home screen 200 of FIG. 9A, the client application 41B causes the user interface 14B of the terminal 1B to display an edit label display screen 700 shown in FIG. 9B. The edit label display screen 700 displays sample images 701 and 702 of label data stored in the terminal 1B and usable by the client application 41B in a selectable manner. The label data usable by the client application 41B may be label data created or edited by the client application 41B or label data downloaded from the label management server 3. For example, the sample image 701 corresponds to the posted label data 42 downloaded by the user B from the label management server 3.

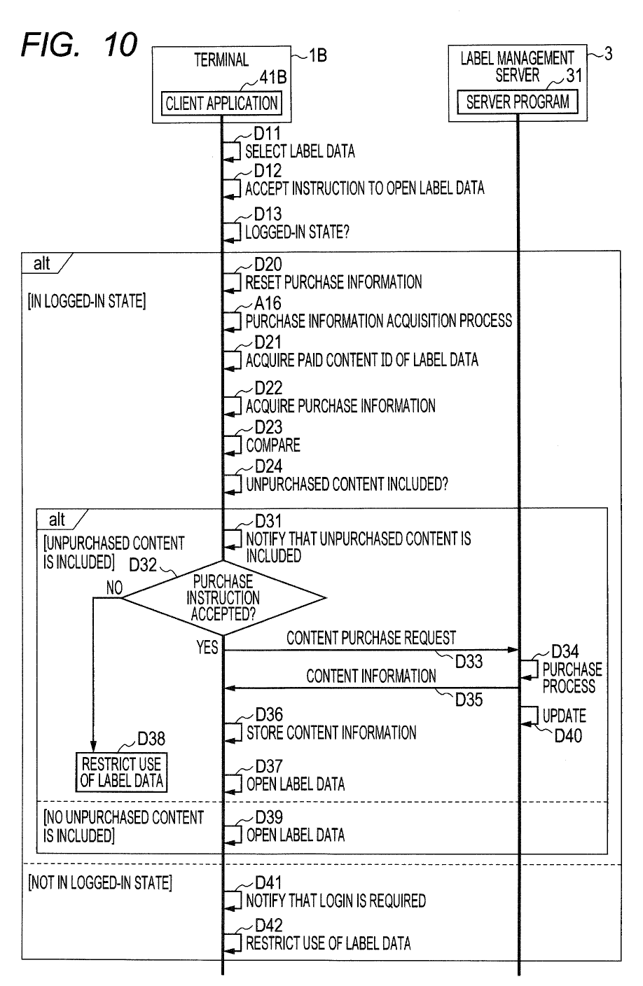

In response to accepting an operation of selecting the sample image 701, the client application 41B accepts a selection of label data (D11) and further accepts an instruction to open the selected label data (D12), as shown in FIG. 10. D11 is an example of “selection process”. The client application 41B determines whether it is in a logged-in state (D13).

When the login information 44 is not stored in the memory 12B, the client application 41B determines that the client application 41B is not in the logged-in state (alt: not in logged-in state). In this case, since the client application 41B has not acquired the purchase information corresponding to the user ID of the login user, the client application 41B causes the terminal 1B to display a login notification screen 511 shown in FIG. 9C (D41). The login notification screen 511 includes a message 512 for notifying that login is requested and an OK button 514. D41 is an example of “login notification process”.

The client application 41B also restricts the use of the selected posted label data 42 (D42). The restriction of use of the selected label data includes not allowing opening the selected label data, not allowing editing the selected label data even if the selected label data is opened, and not allowing printing the selected label data. The phrase “not allowing opening” the label data 42 means that an instruction to open the data may not be accepted in a state where the label data is selected, or even if the instruction is acceptable, a process of opening the label data may be canceled and notifying an error after the instruction is accepted. The same applies to “not allowing printing” and “not allowing editing” of the label data 42. This prevents the user C from using label data which cannot be determined whether the label data includes paid content or function which the user C has not purchased. D42 is an example of “paid label restriction process”.

When the login information 44 is stored in the memory 12B, the client application 41B determines that the client application 41B is in a logged-in state (alt: in logged-in state). In this case, the client application 41B resets the purchase information 45 stored in the memory 12B (D20), and executes the purchase information acquisition process (A16). The procedure of the purchase information acquisition process has been described above, and therefore, the description is omitted. In this way, the client application 41B stores the purchase information 45 corresponding to the user ID “aaa3” of the login user C in the memory 12B immediately before opening the posted label data 42. This increases the accuracy of determining the presence or absence of unpurchased paid contents or functions.

As shown in FIG. 10, the client application 41B acquires the paid content ID of the paid content or function set in the selected posted label data 42 (D21). For example, the client application 41B acquires the paid content ID from the selected posted label data 42. The client application 41B acquires the purchase information 45 corresponding to the user ID of the user C from the memory 12B (D22).

The client application 41B compares the paid content ID of the posted label data 42 acquired in D21 with the purchase information 45 acquired in D22 (D23), and determines whether unpurchased paid content or function is included in the selected posted label data 42 (D24). In a case where at least one of the paid content IDs acquired in D21 is not included in the purchase information 45 acquired in D22, the client application 41B determines that unpurchased paid content or function is included in the selected posted label data 42. In a case where all of the paid content IDs acquired in D21 are included in the purchase information 45 acquired in D22, the client application 41B determines that no unpurchased paid content or function is included in the selected posted label data 42. D24 is an example of “determination process”.

In this embodiment, as shown in FIG. 2B, the posted label data 42 to which a label ID “ddd1” is attached includes the paid content IDs “ctn1” and “ctn4”. As shown in FIG. 2A, the purchase information 45 corresponding to the user ID “aaa3” of the user C does not include the paid contents IDs “cnt1” and “cnt4”. Therefore, the paid content ID of the paid content or function set in the posted label data 42 is not included in the purchase information 45 of the login user C. In this case, the client application 41B determines that the paid content or function not purchased by the user C is included in the selected posted label data 42 (alt: unpurchased content is included), and notifies that the selected posted label data 42 includes the content or function which has not been purchased (D31). D31 is an example of “notification process”.

The client application 41B of this embodiment causes the user interface 14B of the terminal 1B to display an unpurchased-content notification screen 501 shown in FIG. 9D. For example, the unpurchased-content notification screen 501 includes an unpurchased-content notification message 502, a purchase suggestion message 503, a purchase button 504, and a non-purchase (cancel) button 505. The unpurchased-content notification message 502 includes a message notifying that the selected label data includes unpurchased content or function. The unpurchased-content notification message 502 may include a message notifying that the selected label data is not usable because the selected label data includes unpurchased content or function. The purchase suggestion message 503 includes a message suggesting the purchase of the content or function which has not been purchased yet. The purchase button 504 is an operation object for accepting a purchase instruction to purchase an unpurchased content or function. The non-purchase button 505 is an operation object for accepting an instruction for not purchasing unpurchased content or function.

The purchase button 504 is associated with, for example, a URL corresponding to a content purchase screen. When the client application 41B accepts a purchase instruction in response to an operation of the purchase button 504 (D32: YES), the client application 41B accesses the URL and requests purchase of the content (D33).

The label management server 3 performs a purchase process (D34). For example, the label management server 3 provides the terminal 1B with the content purchase screen and causes the client application 41B to display the content purchase screen. When the unpurchased paid contents IDs “cnt1” and “cnt4” are stored in the received query of the URL, the label management server 3 may display the contents purchase screen in a state where the paid contents corresponding to the paid contents IDs “cnt1” and “cnt4” are automatically selected.

According to this, the content purchase screen is displayed on the terminal 1B by tapping the purchase button 504. Thus, for example, the user C does not need to perform an operation procedure of operating the server use button 203 to display the label search screen 300 on the terminal 1B, and tapping the point content tab 322 displayed on the label search screen 300 as shown in FIG. 4E, thereby switching the label search screen to the content purchase screen. Therefore, the client application 41B reduces operations for purchasing unpurchased contents or functions, and encourages the user C to purchase paid contents.

As shown in FIG. 10, when the purchase process is completed, the label management server 3 reads out the paid content information 46 corresponding to the paid content IDs “cnt1” and “cnt4” from the content database 8 and transmits the paid content information 46 to the client application 41B (D35). The client application 41B receives the paid content information 46 via the communication interface 13B, and stores the paid content information 46 in the memory 12B (D36). The label management server 3 updates the user database 6 in the same manner as in G07 in FIG. 3 (D40). Thereafter, the client application 41B opens the selected posted label data 42 (D37). For example, the client application 41B opens the content of the posted label data 42 on the editing screen to edit the posted label data 42, or transmits the posted label data 42 to a label printer to print the posted label data 42.

In contrast, when the client application 41B accepts an operation of the non-purchase button 505, the client application 41B does not accept the purchase instruction (D32: NO). In this case, the client application 41B restricts the use of the posted label data 42 as in D42 (D38). D38 is an example of “selected label restriction process”.

When all the paid contents IDs of the posted label data 42 acquired in D21 are included in the purchase information 45 acquired in D22, the client application 41B determines that no unpurchased paid content or function is included in the selected label data (D24, alt: No unpurchased content is included). In this case, the client application 41B opens the selected label data, for example (D39). The processing in D39 is the same as that in D37, and the description is omitted.

In a known technique, when users B and C share the posted label data 42 by using a file sharing function, the user C is able to access, from a terminal 1C, and use the posted label data 42 downloaded by the user B using the terminal 1B.

However, by executing the process shown in FIG. 10, a client application 41C of the terminal 1C acquires purchase information corresponding to the user ID of the user C before the user C selects and opens the posted label data 42, determines that the posted label data 42 includes paid content that the user C has not purchased, and notifies the user of the determination result or restricts the use of the posted label data 42.

As described in detail above, when the paid content or function included in the selected label data 42 is not purchased, the terminal 1 having the client application 41 of this embodiment executes the client application 41 to notify that the selected label data 42 includes unpurchased content or function. This enables the log-in user who uses the client application 41 to notice that unpurchased content or function is included. As a result, the purchase of unpurchased content or function is promoted. Therefore, according to the present embodiment, a technique for facilitating the use of label data including a setting of paid content or function in a system for using label data is realized.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

The number of printers connected to the terminal is not limited to the example shown in the figure, and may be two or more. In the various notifications described above, warning sounds and voices may be combined with messages and so on. The purchase information may be periodically acquired during a period in which the client application 41 is being executed.

The processing of D38 shown in FIG. 10 may be omitted. However, by restricting the use of label data including unpurchased content or function, the login user is encouraged to purchase the unpurchased content or function.

The processing of A16 shown in FIG. 5A may be omitted. However, the client application 41 acquires the purchase information of the login user in response to a successful login. Thus, it is determined whether the login user has already purchased the paid content or function included in the selected label data in the logged-in state.

The processing of A16 shown in FIG. 6 may be omitted. Further, when the server use button 203 is operated, the purchase information may not be acquired from the label management server 3. In the above-described embodiment, however, the purchase information is acquired in a case where the system is restarted in a state where the user is logged in or a case where an operation to use the label management server 3 is accepted after the user has successfully logged in. Therefore, even in a case the user successfully logs in and then the user purchases a paid content or function by using another program or another device, the client application 41 acquires the purchase information reflecting the purchased content from the label management server 3 and updates the purchase information stored in the terminal 1. This enables the client application 41 to accurately determine whether the paid content or function has been purchased.

The processing after D13 in FIG. 10 may be omitted. In the above-described embodiment, however, when an instruction to open the selected label data is given, the purchase information corresponding to the login ID is acquired, whereby the purchase information is updated immediately before it is determined whether the paid content or function has been purchased. Thus, it is determined accurately whether the paid content or function has been purchased. Compared with the case where the purchase information acquisition process is executed when the login is successful or when the login is already completed at the time of restart as shown in FIGS. 5A and 6, the purchase information immediately before the determination process is acquired. This improves determination accuracy. On the other hand, by acquiring the purchase information when the login is successful or when the login is already completed at the time of restart as shown in FIGS. 5A and 6, it takes less time to open the label data than the case where the purchase information acquisition process is executed when the label data is opened as shown in FIG. 10.

In the unpurchased-content notification screen 501, the purchase suggestion message 503, the purchase button 504, and the non-purchase button 505 may be omitted, and it may be notified that unpurchased paid content or function is included. In the above-described embodiment, however, since unpurchased content or function can be purchased through the unpurchased-content notification screen 501 in the client application 41, the time and effort for the purchase is reduced.

The processing of D41 in FIG. 10 may be omitted. However, in a state where the user is not logged in to the label management server 3, the user cannot be identified, and it cannot be determined whether paid content or function is purchased. Therefore, when the client application 41 receives selection of the label data including paid content or function in a state where the user is not logged in, the client application 41 notifies the user that the user is requested to log in. This enables the user to easily notice that the user is not logged in and prompts the user to perform the login operation.

The processing of D42 in FIG. 10 may be omitted. In the above-described embodiment, however, in a state where the user is not logged in to the label management server 3, the use of label data including paid content or function is restricted. This prevents the user who has not purchased the paid content or function from using the label data.

In the client application 41, a print button may be displayed on the edit label display screen 700 shown in FIG. 9B, and may receive an operation of the print button in a state where the sample image 701 is selected, for example, thereby accepting a print instruction without opening the label data 42. In this case, in the client application 41, D12 in FIG. 10 may be changed to a process of accepting a print instruction, D37 and D39 may be changed to a process of transmitting print data to a label printer, and D38 and D42 may be changed to a process of not transmitting print data. This enables the client application 41 to accurately determine whether unpurchased paid content or function is included, immediately before the label data is printed, and if it is determined that unpurchased paid content or function is included, notification may be performed or printing may be restricted.

The label database 7 may be divided into a plurality of databases. For example, label data may be stored in a database different from the label database 7, and the URL allocated to each label data may be stored in the label database 7 instead of the label data 73. Further, an object management database for managing objects usable for label data may be provided separately from the label database 7, and the paid content ID may not be stored in the label data. The label management server 3 may compare paid content or function set in the label data with objects in the object management database to create a paid content list.

In the download procedure shown in FIG. 8, the label management server 3 transmits the label data of the download target to the terminal 1B even when the label data of the download target includes content or function that the login user has not purchased yet. Alternatively, the label management server 3 may have a function of determining whether the content or function which has not been purchased by the login user is included in the label data of the download target, based on the purchase information of the login user. For example, in B24 of FIG. 8, the label management server 3 reads out, from the label database 7, the label data and the paid content list associated with the received label ID. The label management server 3 reads out the purchase information corresponding to the received user ID from the user database 6.

When all the paid content IDs included in the read paid content list are included in the read purchase information, the label management server 3 determines that no unpurchased content or function is included in the posted label data of the download target, and transmits the read label data to the client application 41B. In contrast, when at least one of the paid content IDs included in the read paid content list is not included in the read purchase information, the label management server 3 determines that unpurchased content or function is included in the label data of the download target, and does not transmit the read label data to the client application 41B. This prevents label data including unpurchased paid content or function from being downloaded to the terminal 1B and used.

In any sequence diagram disclosed in the embodiment, the execution order of any plurality of processes may be changed or may be executed in parallel as long as the processes do not contradict each other.

The processes disclosed in the embodiment may be performed by a single CPU, multiple CPUs, hardware such as an ASIC, or a combination of these elements. The processes disclosed in the embodiment may be realized in various forms such as a recording medium or a method on which a program for executing the processes is recorded.

What is claimed is:

1. A non-transitory computer-readable storage medium storing a program including a set of program instructions for an information processing apparatus comprising a computer, the set of program instructions, when executed by the computer, causing the information processing apparatus to perform:
requesting a login to a server by using a user ID of a login user, the server being configured to store label data, the label data being printable by a label printer, the label data being configured to include a setting of paid content or function, the server being configured to access a purchase information database, the purchase information database storing purchase information indicating, for each of a plurality of user IDs, whether paid content or function has been purchased;
in a logged-in state on the server, downloading, from the server, at least one label data stored in the server and storing the downloaded label data in a memory of the information processing apparatus;
acquiring, via the server, the purchase information corresponding to the user ID of the login user;
selecting label data to be used;
determining, based on the acquired purchase information, whether the selected label data includes a setting of unpurchased paid content or function; and
in response to determining that the selected label data includes the setting of unpurchased paid content or function, controlling a user interface of the information processing apparatus to notify that the selected label data includes unpurchased paid content or function.

2. The non-transitory computer-readable storage medium according to claim 1, wherein, when executed by the computer, causing the information processing apparatus to perform:
in response to determining that the selected label data includes the setting of unpurchased paid content or function, restricting use of the selected label data.

3. The non-transitory computer-readable storage medium according to claim 2, wherein the restricting includes restricting use of the selected label data by not allowing opening the selected label data.

4. The non-transitory computer-readable storage medium according to claim 2, wherein the restricting includes restricting use of the selected label data by not allowing printing the selected label data.

5. The non-transitory computer-readable storage medium according to claim 2, wherein the restricting includes restricting use of the selected label data by not allowing editing the selected label data.

6. The non-transitory computer-readable storage medium according to claim 1, wherein, when executed by the computer, causing the information processing apparatus to perform:
in a case where the login to the server is successful, acquiring, via the server, the purchase information corresponding to the user ID of the login user.

7. The non-transitory computer-readable storage medium according to claim 6, wherein, when executed by the computer, causing the information processing apparatus to perform:
in a case where the program is ended in the logged-in state and then the program is started, requesting the login to the server; and
in a case where the login to the server is successful, acquiring, via the server, the purchase information corresponding to the user ID of the login user.

8. The non-transitory computer-readable storage medium according to claim 6, wherein, when executed by the computer, causing the information processing apparatus to perform:
in a case where the login to the server is successful and then a particular operation for using the server is accepted via the user interface, acquiring, via the server, the purchase information corresponding to the user ID of the login user.

9. The non-transitory computer-readable storage medium according to claim 1, wherein, when executed by the computer, causing the information processing apparatus to perform:
in response to accepting an instruction to open the selected label data, acquiring, via the server, the purchase information corresponding to the user ID of the login user before determining whether the selected label data includes the setting of unpurchased paid content or function.

10. The non-transitory computer-readable storage medium according to claim 1, wherein, when executed by the computer, causing the information processing apparatus to perform:
in a case where it is notified that the selected label data includes unpurchased paid content or function, accepting a purchase instruction of purchasing the unpurchased paid content or function included in the selected label data; and
in response to accepting the purchase instruction, executing a purchase process of purchasing the unpurchased paid content or function.

11. The non-transitory computer-readable storage medium according to claim 1, wherein, when executed by the computer, causing the information processing apparatus to perform:
in a case where label data including a setting of paid content or function is selected in a state of not logged in on the server, controlling the user interface to notify that a login is requested.

12. The non-transitory computer-readable storage medium according to claim 11, wherein, when executed by the computer, causing the information processing apparatus to perform:
in a case where label data including a setting of paid content or function is selected in a state of not logged in on the server, restricting use of the selected label data.

13. The non-transitory computer-readable storage medium according to claim 1, wherein the label data downloaded by a first login user is accessible by a second login user different from the first login user;
wherein the selecting the label data includes allowing the second login user to select the downloaded label data stored in the memory, the downloaded label data being downloaded from the server by the first login user.

14. The non-transitory computer-readable storage medium according to claim 1, wherein the label data stored in an other device different from the information processing apparatus is sharable by file sharing; and
wherein the selecting the label data includes allowing the login user to select the downloaded label data stored in the other device, the downloaded label data being downloaded from the server by the other device.

15. The non-transitory computer-readable storage medium according to claim 1, wherein, when executed by the computer, causing the information processing apparatus to perform:
after logging in to the server and before acquiring the purchase information from the server, resetting purchase information that is acquired at a previous login and stored in the memory.

16. An information processing apparatus comprising:
a communication interface; and
a controller configured to perform:
requesting a login to a server, via the communication interface, by using a user ID of a login user, the server being configured to store label data, the label data being printable by a label printer, the label data being configured to include a setting of paid content or function, the server being configured to access a purchase information database, the purchase information database storing purchase information indicating, for each of a plurality of user IDs, whether paid content or function has been purchased;
in a logged-in state on the server, downloading, from the server, at least one label data stored in the server and storing the downloaded label data in a memory of the information processing apparatus;
acquiring, via the server, the purchase information corresponding to the user ID of the login user;
selecting label data to be used;
determining, based on the acquired purchase information, whether the selected label data includes a setting of unpurchased paid content or function; and
in response to determining that the selected label data includes the setting of unpurchased paid content or function, controlling a user interface of the information processing apparatus to notify that the selected label data includes unpurchased paid content or function.

17. A label data sharing system comprising:
a first information processing apparatus;
a second information processing apparatus; and
a server, the first information processing apparatus and the second information processing apparatus being connectable to the server via a network, the server being configured to store label data in association with a user ID, the label data being printable by a label printer, the label data being configured to include a setting of paid content or function, the server being configured to access a purchase information database, the purchase information database storing purchase information indicating, for each of a plurality of user IDs, whether paid content or function has been purchased,
the server configured to perform:
in response to receiving a request for login, execute a login process based on a user ID associated with the request for login,
the first information processing apparatus configured to perform:
requesting a login to the server by using a first user ID of a first login user;
uploading, to the server, label data in association with the first user ID in a logged-in state on the server, the uploaded label data being the label data stored in the first information processing apparatus;
the server configured to store the label data uploaded from the first information processing apparatus, as posted label data, in association with the first user ID;
the second information processing apparatus configured to perform:
requesting a login to the server by using a second user ID of a second login user;
in a logged-in state on the server, downloading, from the server, at least one posted label data stored in the server and storing the downloaded posted label data in a memory of the second information processing apparatus;
acquiring, via the server, the purchase information corresponding to the second user ID;
selecting posted label data to be used;
determining, based on the acquired purchase information, whether the posted selected label data includes a setting of unpurchased paid content or function; and
in response to determining that the selected posted label data includes the setting of unpurchased paid content or function, controlling a user interface of the second information processing apparatus to notify that the selected posted label data includes unpurchased paid content or function.
